(19) United States
(12) Patent Application Publication
(10) Pub. No.: US 2012/0290714 A1
(43) Pub. Date: Nov. 15, 2012

(54) METHOD AND APPARATUS FOR PROVIDING HEURISTIC-BASED CLUSTER MANAGEMENT

(75) Inventor: John Cohen, Nahant, MA (US)

(73) Assignee: Nokia Corporation, Espoo (FI)

(21) Appl. No.: 13/107,652

(22) Filed: May 13, 2011

(51) Int. Cl. G06F 15/173

(52) U.S. Cl. 709/224; 709/223

(57) ABSTRACT

An approach is provided for heuristic-based cluster management. A cluster management framework receives a request for specifying at least one management process on at least one cluster of one or more servers. The cluster management framework determines one or more heuristics associated with the at least one management process, the at least one cluster, the one or more servers, or a combination thereof. The cluster management framework then processes and/or facilitates a processing of the one or more heuristics to cause, at least in part, a generation of a plan for implementing the at least one management process.

### BACKGROUND

Service providers and device manufacturers (e.g., wireless, cellular, etc.) are continually challenged to deliver value and convenience to consumers by, for example, providing compelling network services. Important differentiators in the industry are application and network services as well as capabilities to support and scale these services. In particular, these applications and services can include accessing and managing data utilized, for example, by social services, media services, employment services, etc. These services may be implemented via one or more servers and/or clusters of servers. These servers and/or clusters may need to be maintained to redistribute load when a server requires to be serviced, needs to be replaced, is overloaded, or performs any other management process applicable to the clusters and/or servers. However, technical challenges exist in quickly and efficiently rebalancing such servers and/or clusters while reducing any potential downtime to services utilizing the servers and/or clusters. In particular, service providers and device manufacturers face significant challenges to incorporating heuristics, logic, rules, etc. to more effectively plan or implement management processes (e.g., rebalancing or other operations that might lead to rebalancing) on the clusters and/or servers.

### SOME EXAMPLE EMBODIMENTS

Therefore, there is a need for an approach for providing heuristic-based cluster management.

According to one embodiment, a method comprises receiving a request for specifying at least one management process on at least one cluster of one or more servers. The method also comprises determining one or more heuristics associated with the at least one management process, the at least one cluster, the one or more servers, or a combination thereof. The method further comprises processing and/or facilitating a processing of the one or more heuristics to cause, at least in part, a generation of a plan for implementing the at least one management process.

According to another embodiment, an apparatus comprises at least one processor, and at least one memory including computer program code for one or more programs, the at least one memory and the computer program code configured to, with the at least one processor, cause, at least in part, the apparatus to receive a request for specifying at least one management process on at least one cluster of one or more servers. The apparatus is also caused to determine one or more heuristics associated with the at least one management process, the at least one cluster, the one or more servers, or a combination thereof. The apparatus is further caused to process and/or facilitate a processing of the one or more heuristics to cause, at least in part, a generation of a plan for implementing the at least one management process.

According to another embodiment, a computer-readable storage medium carries one or more sequences of one or more instructions which, when executed by one or more processors, cause, at least in part, an apparatus to receive a request for specifying at least one management process on at least one cluster of one or more servers. The apparatus is also caused to determine one or more heuristics associated with the at least one management process, the at least one cluster, the one or more servers, or a combination thereof. The apparatus is further caused to process and/or facilitate a processing of the one or more heuristics to cause, at least in part, a generation of a plan for implementing the at least one management process.

According to another embodiment, an apparatus comprises means for receiving a request for specifying at least one management process on at least one cluster of one or more servers. The apparatus also comprises means for determining one or more heuristics associated with the at least one management process, the at least one cluster, the one or more servers, or a combination thereof. The apparatus further comprises processing and/or facilitating a processing of the one or more heuristics to cause, at least in part, a generation of a plan for implementing the at least one management process.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing heuristic-based cluster management, according to various embodiments;

FIG. 2 is a diagram of the components of a distributed key value store, according to various embodiments;

FIG. 3 is a diagram of the components of a cluster management framework, according to various embodiments;

FIG. 4 is a flowchart of a process for providing heuristic-based cluster management, according to various embodiments;

FIG. 5 is a flowchart of a process for monitoring a cluster to initiate heuristic-based cluster management, according to various embodiments;

FIG. 6 is a Unified Modeling Language (UML) class diagram of a Java-based cluster management framework, according to various embodiments;

FIGS. 7 and 8 are diagrams of heuristic-based cluster management with respect to a rack-based failure domain, according to various embodiments;

FIG. 9 is a diagram of a cluster-based rebalancing process, according to various embodiments;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for providing heuristics-based cluster management are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

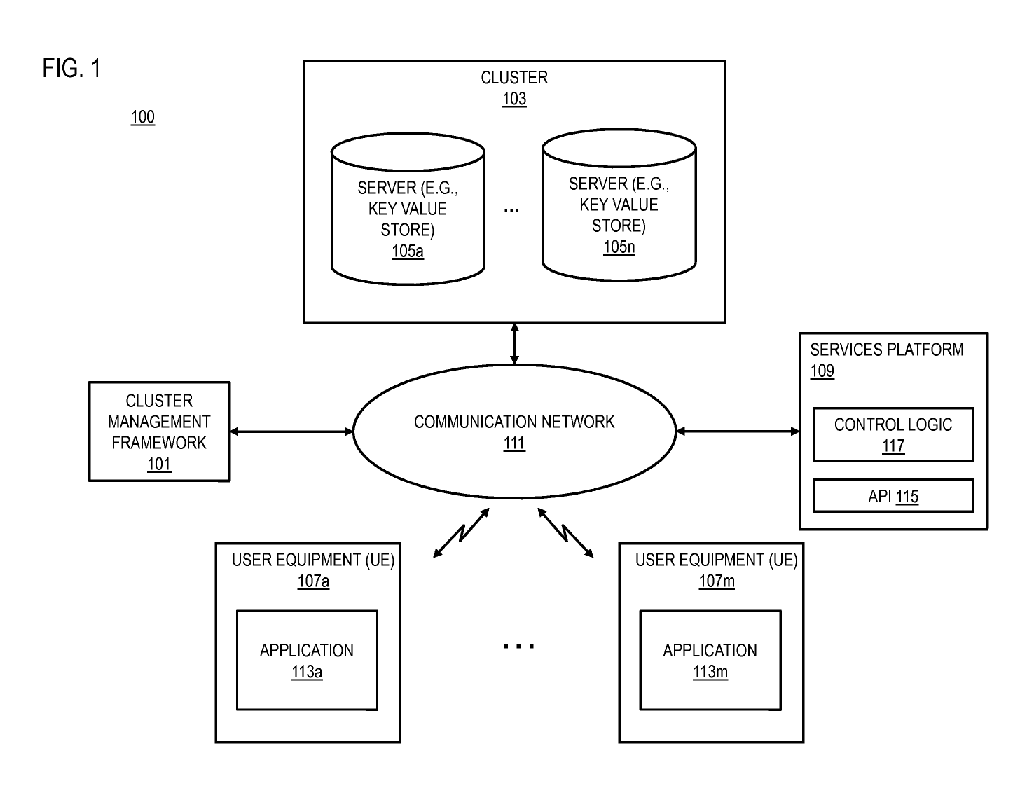

FIG. 1 is a diagram of a system capable of providing heuristic-based cluster management, according to various embodiments. An integral part of such services is providing data to users while allowing for scalability and redundancy as the volume of data handled by the services increases. As a result, service providers have developed storage platforms (e.g., distributed storage platforms) capable of handling vast collections of large databases that store, for instance, information, data, etc. generated by any number of services (e.g., both integrated and individual services). Many of these databases can reach multiple terabytes, petabytes, or more in size.

In some cases, storage platforms can perform any number of management processes that can alter the number of servers or nodes within storage clusters or otherwise affect the distribution or organization of data within the clusters. For example, storage platforms can split larger databases into smaller databases (e.g., partitions or database shards) that are maintained at multiple nodes to allow for the scalability and/or redundancy noted above. One example of a distributed storage platform is a distributed key value store (e.g., a Voldemort-based key-value storage system as described at http://project-voldemort.com/design.php, last accessed May 3, 2011, which is incorporated herein in its entirety) which given a key returns as corresponding value. In some cases, the cluster management processes can be utilized, for example, to rebalance or to trigger the rebalancing of loads on databases. In one embodiment, when a particular database is utilized to a certain threshold, the database system structure can be rebalanced over nodes to provide a more stable and/or more efficient system load for users of the service. Although various embodiments of the approach described herein are discussed with respect to rebalancing, it is contemplated that the various embodiments are also applicable to any other cluster management process (e.g., dynamic addition of new nodes to the cluster, deletion of nodes from the cluster, load balancing inside a cluster, etc.) that may lead to rebalancing or other operations affecting the distribution or organization of data within clusters of servers or nodes. By way of example, rebalancing aims, for instance, to increase or decrease a cluster's capacity by providing the capability to add/delete nodes and/or move data around in a running cluster without downtime and with minimal impact on online cluster performance.

However, such rebalancing traditionally has been time consuming and/or inefficient, thus causing network congestion, delay, and/or other inefficiencies for the system. For example, traditional rebalancing methods are based on manual processes whereby an administrator or other user manually analyzes changes to the cluster to configure the rebalancing or other cluster management process. Such manual process can result in significant burden on the administrator to perform the analysis quickly and accurately. As the complexity and size of the cluster increase, the burden on the Administrator increases accordingly, thereby increasing the time, complexity of analysis, and/or potential risk of errors. Error in the rebalance plan (e.g., when done manually) can result in data (e.g., partitions) begin unavailable to other applications and eventually breaking data consistency within the cluster. Moreover, recovery from errors, prior to a manual rebalancing can potentially result in data lost and/or integrity problems.

To address these problems, a system 100 of FIG. 1 introduces a cluster management framework 101 that provides a mechanism to proactively suggest a strategy or plan to implement requested management processes (e.g., rebalancing) on a cluster 103 of servers 105a-105n or nodes (also collectively referred to as servers 105). More specifically, the cluster management framework 101 is based, at least in part, on an architecture that enables heuristic pieces of logic that can be “plugged-in” into the framework to extend its capabilities. By way of example, the heuristics (e.g., the heuristic pieces of logic) incorporate rules and/or decision making into the cluster management processes (e.g., rebalancing) that can be applied to influence how and when the cluster management process is created and/or executed. In various embodiments, heuristic-based refers to experience-based techniques for problem solving, learning, and/or discovery of factors, parameters, etc. that can influence or affect the implementation or development of a plan for implementation of a requested cluster management process. For example, with respect to rebalancing a cluster, production cluster requirements typically develop and change over time, and therefore, are often unknown at the time the system 100 (or the cluster 103 within the system 100) are designed and built. In this case, the pluggable design of the heuristics can make the system 100 more flexible by enabling efficient incorporation of new heuristics to address such requirements, thereby avoiding potentially burdensome future maintenance and/or updates to the system 100.

In one embodiment, the heuristics of the cluster management framework 101 are individualistic. In other words, each heuristic plug-in or module provides specific information for at least one aspect of the overall system 100 that can be used to determine or plan a strategy to implement a requested cluster management operation (e.g., a rebalancing). In embodiments where multiple heuristic plug-ins are used, the collective knowledge contributed by the individual plug-ins can be combined to determine a strategy or plan. Examples of heuristics include, at least in part: (1) heuristics for evenly distributing partitions of data among the servers 1015 or nodes of the cluster 103, thereby maintaining a balance geometry or arrangement of the cluster 1031; (2) heuristics for failure domain awareness that account for relationships to potential conditions that might affect the failure of one or more of the servers 105 within the cluster 103 (e.g., location-awareness of servers 105, such as location of servers 105 within particular racks, data centers, etc., where failure of the location or rack can potential result in failure of the servers 105 associated with the location or rack); (3) heuristics for monitoring available resources of the servers 105 (e.g., resources associated with heterogeneous environments including, for instance, *NIX, Windows, etc.); and/or (4) any other heuristics or rule to account for parameters or conditions of interest that might affect cluster management processes.

In some embodiments, the system 100 receives a request to initiate a cluster management process (e.g., rebalancing, adding/deleting servers 105, etc.). In response to the request, the system 100 uses the cluster management framework 101 to evaluate the requested management process against data (e.g., current conditions, available resources, historical use patterns, etc.) associated with a subject cluster 103 to against one or more heuristics. In one embodiment, the system 100 presents the resulting evaluation or a plan to an Administrator for consideration and implementation. In other embodiments, the system 100 can automatically initiate the plan to implement the requested management process without further intervention from the Administrator. In yet another embodiment, the system 100 may monitor the cluster 103 against one or more criteria (e.g., resource availability, resource utilization, node health, error rates, etc.). Based, at least in part, on this monitoring, the system 100 can initiate the heuristics evaluation to generate and/or implement an appropriate cluster management process. For example, if monitoring indicates that a particular server 105 within the cluster 103 is hosting a popular data resource (e.g., a growing database or database that is heavily accessed), the system 100 can initiate a load balancing process. Prior to load balancing, the system 100 applies heuristics to account for factors (e.g., failure domains, data distribution, etc.) that can affect the load balancing process.

In other words, it is contemplated an Administrator or other user of the system 100 can use the cluster management framework 101 to manage the cluster 103 in real-time (e.g., to respond to changing loads or service conditions). In another embodiment, an Administrator can also use the framework 101 to (1) evaluate the potential implications or a proposed cluster management process before actually implementing the process; (2) monitor the health or functioning of a cluster and then proactively implement processes (e.g., rebalancing) to address any potential concerns or problems with the cluster; and the like. Moreover, the various embodiments of heuristics-based cluster management approach described herein enables the system 100 to automatically generate implementation plans without manual planning, thereby reducing potential errors particularly when the clusters 103 to manage are complex or large in size (e.g., thousands of databases spread across multiple clusters 103 and servers 105).

As shown in FIG. 1, user equipment (UEs) 107a-107m (also collectively referred to as UEs 107) can request services from a services platform 109 via a communication network 111. In addition, the services platform 109 has connectivity to at least one cluster 103 of one or more servers 105 for providing the requested services and/or data associated with the services. In one embodiment, respective applications 113a-113m (also collectively referred to as applications 113; e.g., a services application, a map application, a social networking application, etc.) of the UEs 107 can request such services via an application programming interface (API) 115 of the services platform 109. Control logic 117 of the services platform 109 receives such requests and utilizes at least one cluster (e.g., the cluster 103) of servers 105, such as a key value store, to provide services and related data to the applications 113.

The cluster 103 may consist of one or more databases that can be structured utilizing one or more systems. As noted above, the databases of the cluster 103 and/or servers 105 can be a distributed key value store. In certain embodiments, a distributed key value store allows for the storage of values by key. The value itself can be a corpus or body of information that need not be structured. An index of keys can be generated to search for keys that may be useful to users. The key can then be retrieved and sent to a client system. Although various embodiments are described with respect to the key value store, it is contemplated that the approach described herein may be used with other databases (e.g., a distributed database under the control of a database management system, where the storage devices are not all attached to a common processor or a non-distributed database). Key based storage can additionally be useful for social services (e.g., where the key is tied to a user profile), user sessions, shopping carts (e.g., where the key is for a shopping selection for an account of the user), or the like. In some embodiments, the cluster 103 and/or servers 105 can include one or more shard and/or horizontal partitioning systems. In certain embodiments, horizontal partitioning is a database where rows of a database table are separated instead of separating by columns. Each partition/separation can constitute a shard. The shards can further be partitioned by one or more rows.

While providing services to client systems (e.g., UEs 107, services platform 109, etc.), the control logic 117 can forward or otherwise perform queries on information of the cluster 103. In certain scenarios, the cluster 103 can include one or more databases (e.g., shards, partitions, etc.). As queries are performed, the one or more of the databases that makeup a subset of the data stored in the cluster 103 can become overloaded or otherwise require rebalancing (e.g., based on the addition or subtraction of a server 105 or node). Accordingly, an Administrator, the cluster 103, the system 100, or the like may initiate a request to perform one or more cluster management operations (e.g., add/delete nodes, load balance, etc.) that may result in rebalancing of the cluster 103. When a determination is made to rebalance the cluster 103, the cluster management framework 101 can determine at least one or a part of the database to rebalance and then generate a plan for the rebalancing that is based, at least in part, on application of one or more heuristics as discussed with respect to various embodiments described herein. As noted, the heuristics can provide rules or logic for determining an appropriate strategy or plan for implementing a requested cluster management process (e.g., a rebalancing) while also ensuring maximum uptime and minimal disruption to the functioning of a production or online cluster 103.

By way of example, the communication network 111 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 107 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 107 can support any type of interface to the user (such as “wearable” circuitry, etc.).

By way of example, the UE 107 and services platform 109 communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

Further, communications between servers 105 of the cluster 103 can be performed via one or more of the aforementioned protocols and/or technologies. Further, fast connections (e.g., gigabit Ethernet, fiber channel, etc.) can be utilized between nodes of a cluster, between nodes and backend storage, etc.

In one embodiment, the services platform 109 may interact according to a client-server model with the applications 113 of the UE(s) 107, and/or other components of the system 100. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. A cluster 103 of nodes or servers 105 can perform the service 103. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

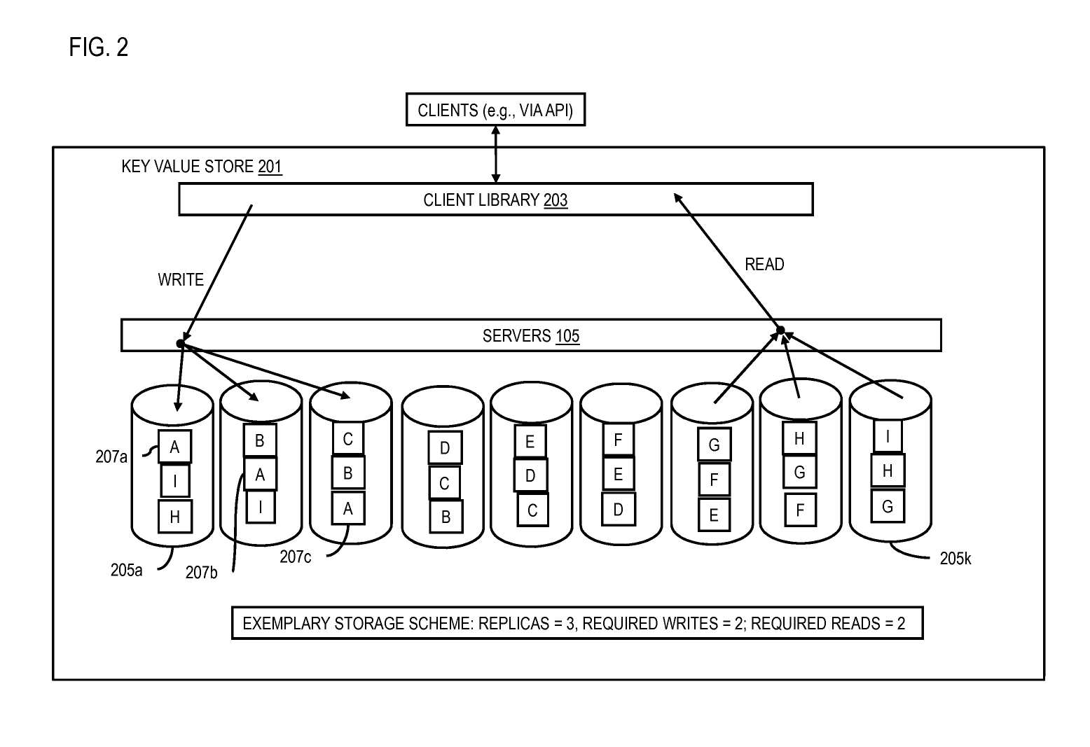

FIG. 2 is a diagram of the components of a distributed key value store, according to various embodiments. By way of example, the key value store 201 includes one or more components for providing storage of data that can be indexed, stored, retrieved, and searched. In certain embodiments, the key value store 201 includes data stored utilizing keys. Further, the key value store 201 can be distributed (e.g., stored using one or more clusters 103 and/or servers 105 at one or more locations). It is contemplated that the functions of these components may be combined in one or more components or performed by other components of equivalent functionality. It is further contemplated that other forms of databases may be utilized in place of or in addition to the key value store 201. In this embodiment, the key value store 201 includes a client library 203 that may be used to communicate with servers 105, and databases 205a-205k (also collectively referred to as databases 205) stored on the servers 105.

The control logic 117 and/or API 115 may communicate with the key value store 201 using a client library 203. In certain embodiments, the control logic 117, API 115, services platform 109, or applications 113 on UEs 107 may be considered clients receiving database services from the key value store 201. The client library 203 may include an interface that can determine which servers 105 to communicate with to retrieve content from databases 205. In certain embodiments, databases 205 are stored utilizing a key and value mechanism that allows storage using the key. A portion (e.g., a partition, a shard, etc.) of each database (e.g., portions A-I as depicted in FIG. 2) can be linked to a key. In one embodiment, the key is hashed to determine which portion the key is linked to. A key may be hashed using a ring method, for example. Using the ring, each key and portion may be hashed to a primary location (e.g., based on a key with an identifier that is hashed into a number k) as well as one or more backup locations. The backup locations may be locations associated with the next server or host associated with the hash. The client library 203 determines which servers 105 to read and write information from and to using the key hashes. The client library 203 and the servers 105 may each include a lookup table including which portions belong to which servers 105.

In certain embodiments, the portion (e.g., portion A 207a-207c) may be stored using multiple servers over multiple databases 205. In one implementation, portions may be replicated over n number (e.g., replicas=3) of servers 105 and databases 205 for redundancy, failover, and to reduce latency. Moreover, the portions may be written to and read from at the same time by the client library 203. When reading from the databases 205, the client library 203 may determine if there are any consistency issues (e.g., portion 209a does not match portion 209b). Moreover, in certain embodiments, an example storage scheme may require that when performing a write or a read, at least a certain number (e.g., required writes=2, required reads=2 etc.) of portions need to be successfully written or read. This allows for redundancy and quorum consistency. If a database 205a fails or is otherwise incapacitated, a portion 209a associated with the database 205a may be later updated with content it should include by servers 105 having replicated portions 209b, 209c.

The API 115 may request that a key based data structure may be stored in the key value store 201. The new data structure may be assigned a key based, at least in part, on an associated account identifier associated. Then, the key may be hashed to determine a portion (e.g., portion A 209) to store the new data structure in. Next, the data structure is stored in a primary database as well as in backup databases (e.g., replica databases). The profile may be considered a value associated with the key. To retrieve the data structure at a later time, the hash of the key may be used to request the data structure from the server 105 associated with the portion. Then, the key may be utilized to search the portion for the data structure.

The key value store 201 is an example of a particular database structure that can be utilized in rebalancing loads or other cluster management processes. As discussed with respect to the various embodiments described herein, the cluster management framework 101 can apply one or more heuristics to determine a strategy or plan for implementing the rebalancing or other management processes on the key value store 201. It is contemplated that other types of database structures, for example, other key value stores, other databases, other shard databases, other partition based databases, etc. can be utilized in the rebalancing processes mediated by the cluster management framework 101. While rebalancing shards, the load of the master shard and/or replica shards can be transferred. Routing information can be changed based on the status (e.g., master or replica) of the old and/or new node or server 105.

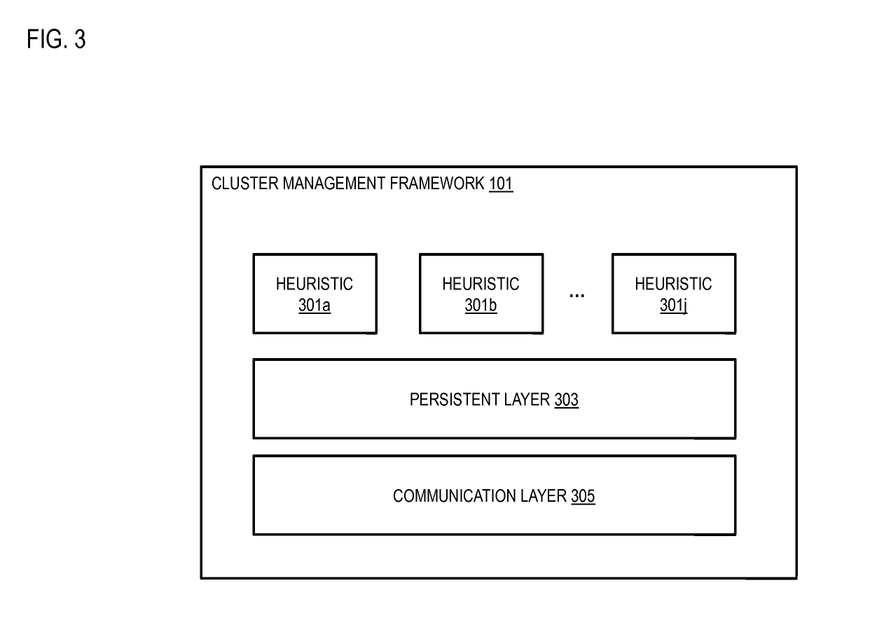

FIG. 3 is a diagram of the components of a cluster management framework, according to various embodiments. By way of example, the process management platform 103 includes one or more components for providing heuristic-based cluster management. It is contemplated that the functions of these components may be combined in one or more components or performed by other components of equivalent functionality. As shown, in one embodiment, the cluster management framework 101 is based on a layered design or architecture that incorporates one or more heuristic modules 301a-301j (also collectively referred to as heuristics 301) as plug-ins to the cluster management framework 101. For example, the heuristics 301 can be used to extend the functionality of the cluster management framework 101 to include additional logic, rules, data, etc. for determining or optimizing the implementation of one or more management processes that operate on at least one cluster 103 of servers 105.

As previously discussed, the heuristics 301 are individual plug-ins that can be used individually or in combination to optimize a cluster management process. By way of example, the heuristics 301 can extend the functionality of the cluster management framework 101 to enable logic to optimize for: (1) even distribution of partitions or shards with the cluster 103, (2) failure domain awareness to avoid to the extent possible have a single point of failure for partitions or shards stored in the cluster 103, (3) monitoring of server 105 resources, etc. For example, failure domain refers to the concept of group servers 105 under certain common failure conditions (e.g., installation in the same rack or location as other servers), wherein each failure condition represents a point-of-failure that will affect in the same manner all the servers 105 associated with the failure condition.

For example, if a group of servers 105 of the cluster 103 are installed at common data center, then failure of that common data center (e.g., via a power loss) will result in failure of all servers 105 located at the data center. In this case, heuristics 301 can be used to provide logic that recognizes the failure domain and then optimizes cluster management operations to mitigate the failure domain. Under this scenario, the heuristics 301 can ensure that replicate data sets are dispersed across servers 105 that are located at different data centers. If no such heuristics 301 are applied, then it is possible that the cluster management framework 101 may rebalance data within the cluster 103 so that replicate data sets may ultimately end up at the same data center, making the data sets more vulnerable to a single point of failure.

In one embodiment, the heuristics 301 interact with the persistent layer 303 to access data about one or more clusters 103 and/or the servers 105 within the clusters 103 for processing. By way of example, the data may include historical information such as resource availability, resource utilization, context associated with use (e.g., time, location, etc.), characteristics of the servers 105 (e.g., capacity, environment, age, location, etc.), etc. In one embodiment, the persistent layer 303 interacts with the communication layer 305 to collect or monitor the data from the cluster 103 of servers 105. In some embodiments, the data collection or monitoring may occur whenever the servers 105 are operational (e.g., to provide real-time or substantially real-time monitoring). In addition or alternatively, the data collection or monitoring may occur according to a schedule, at predetermined intervals, on demand, etc.

In another embodiment, the persistent layer stores data to support data mining for application of the heuristics 301 or for determination of heuristics 301 themselves. For example, the system 100 may mine the historical data to determine under what conditions the one or more of the servers 105 are most utilized. The system 100 can then generate plans to implement cluster management processes that avoid these times, thereby also avoiding degradation of server performance. In another use case, if the utilization rates or storage capacity of a server reaches a predetermined threshold, the system 100 can apply the heuristics 301 to automatically rebalance the cluster 103.

In some embodiments, the data collected or monitored by the persistent layer 303 can be provided via sensors (e.g., location sensors) associated with the servers 105. For example, if the servers 105 are stored in racks, sensors can automatically record and provide the location of a particular server 105 in the rack. Examples of other location sensors include, for instance, GPS receivers, cellular triangulation, etc. Other possible sensors may include environmental sensors for measuring parameters that might affect server or cluster performance (e.g., temperature, humidity, light, etc.).

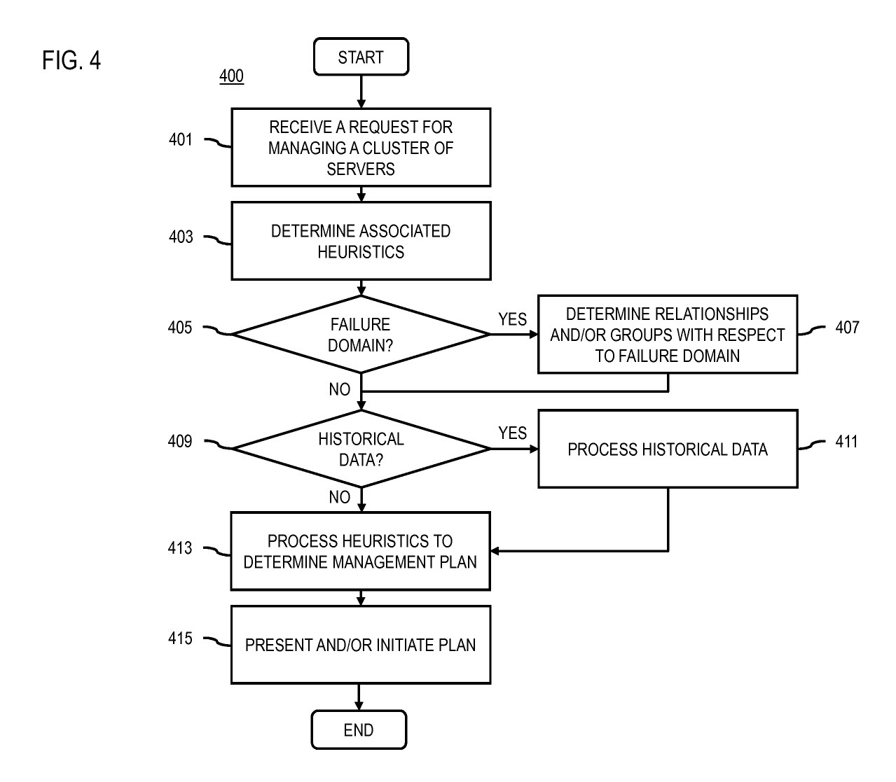

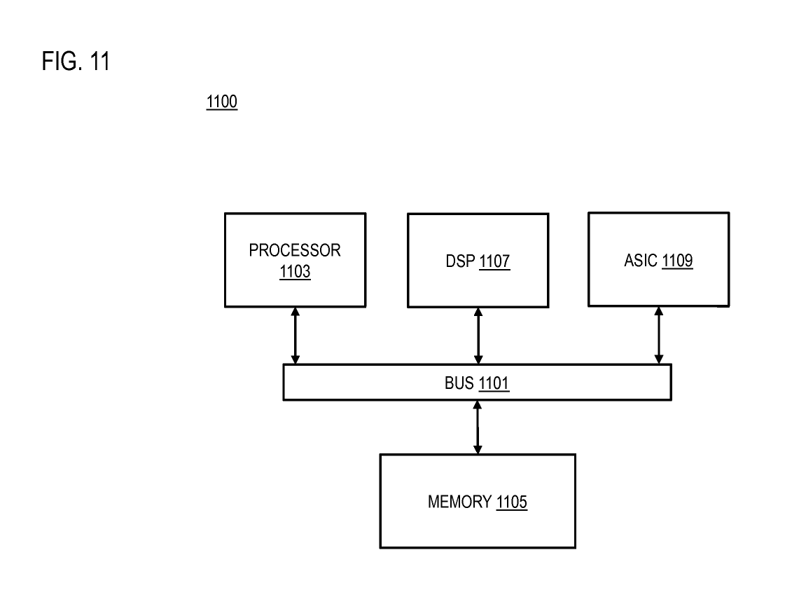

FIG. 4 is a flowchart of a process for providing heuristic-based cluster management, according to various embodiments. In one embodiment, the cluster management framework 101 performs the process 400 and is implemented in, for instance, a chip set including a processor and a memory as shown in FIG. 11. Additionally or alternatively, one or more portions of the process 400 can be implemented via another device (e.g., one or more servers 105 of the cluster 103 such as a head node or management node in charge of rebalancing, etc.).

In step 401, the cluster management framework 101 receives a request for specifying at least one management process on at least one cluster 103 of one or more servers 105. In one embodiment, the at least one management process includes, at least in part, (a) a rebalancing of the cluster in response to an addition of at least one other server, a decommissioning of at least one of the one or more servers, or a combination thereof, (b) a predictive analysis of the at least one cluster, (c) a capacity analysis of the at least one cluster, or (d) a combination thereof. For example, with respect to rebalancing, the determination or request to rebalance can be based on an input from a user (e.g., an administrator). This may occur, for example, if an administrator determines to add or remove a node (e.g., a server) to a distribution of data. Other cluster management processes can include, at least in part, backing up and/or restoring one or more servers 105, performing maintenance on one or more server 105, upgrading components of a server 105, etc.

The cluster management framework 101 then determines one or more heuristics 301 associated with the at least one management process, the at least one cluster 103, the one or more servers 105, or a combination thereof (step 403). If the one or more heuristics 301 relate, at least in part, to one or more failure domains (step 405), the cluster management framework 101 determines one or more relationships among the one or more failure domains, the at least one cluster 103, the one or more servers 105, or a combination thereof (step 407). For example, the one or more relationships may indicate whether one or more of the servers 105 of the cluster 103 are associated with any of the one or more failure domains.

In one embodiment, the one or more failure domains are associated, at least in part, with contextual data of the at least one cluster, the one or more servers, or a combination thereof. By way of example, the contextual data includes, at least in part, respective locations (e.g., within a rack, a data center, a geographic location, etc.) of the servers 105. The contextual data may also include time, activity, resource type, resource availability (e.g., available processing, storage, network, etc. capacity), or any other contextual data. In one embodiment, the cluster management framework 101 causes, at least in part, a grouping of at least a portion of the one or more servers 105 based, at least in part, on the one or more failure domains. The one or more relationships are then based, at least in part, on the grouping.

In step 409, the cluster management determines whether there is historical data (e.g., available via the persistent layer 303) that can be processed via the heuristics 301 or other components of the cluster management framework 101 in response to the requested cluster management process. If historical data is available, the cluster management framework 101 can retrieve and process the historical data via the heuristics 301 (step 411).

In step 413, the cluster management framework 101 processes and/or facilitates a processing of the one or more heuristics 301 to cause, at least in part, a generation of a plan for implementing the at least one management process. In one embodiment, the generation of the plan includes, for instance, determining at least one schedule, at least one means, or a combination thereof for the at least one management process. After the plan is generated, the cluster management framework 101 can present the plan to the user (e.g., an administrator) and/or initiate implementation of the plan directly to perform the requested cluster management process (step 415). For example, the administrator may request just the generation of the plan if the administrator wants only a predictive analysis or to determine available options for performing a particular cluster management process.

In certain embodiments, the cluster management framework 101 can initiate a red-repair process to check and/or ensure the consistency of the cluster 103 following completion of the cluster management process. By way of example, this can be performed on a shard by shard level or a key level. For example, a read-repair process can be utilized to update keys. In a read-repair process, each of the keys in the original database(s) can be queried. The query can be against all replicas of the keys and the most recent version of the data stored based on the key can be utilized to update out-of-date replicas. In one example, the original database node can be queried for keys (e.g., one by one, in parallel, sequentially, etc.). As the keys are being queried, a version number or timestamp associated with different versions of a database, partition, shard, etc. stored in replicas can be compared with a version number or timestamp of the original database and/or another replica or master database portion. If there are discrepancies, the cluster management framework 101 can resolve conflicts by updating inconsistent nodes accordingly.

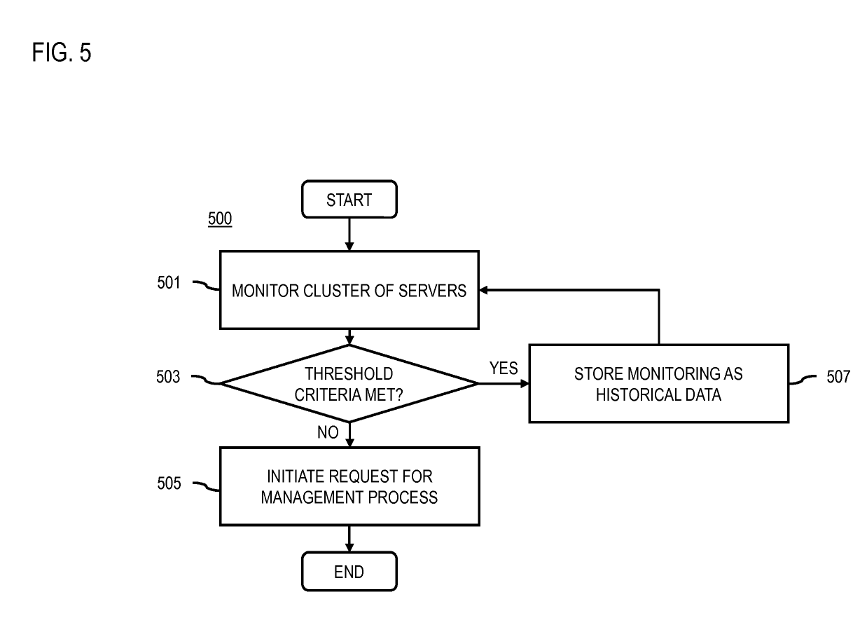

FIG. 5 is a flowchart of a process for monitoring a cluster to initiate heuristic-based cluster management, according to various embodiments. In one embodiment, the cluster management framework 101 performs the process 400 and is implemented in, for instance, a chip set including a processor and a memory as shown in FIG. 11. Additionally or alternatively, one or more portions of the process 400 can be implemented via another device (e.g., one or more servers 105 of the cluster 103 such as a head node or management node in charge of rebalancing, etc.).

In step 501, the cluster management framework 101 causes, at least in part, a monitoring of the at least one cluster, the one or more servers, or a combination thereof. For example, a load or other monitored resource threshold value can be set for particular servers 105 and/or particular shards. Accordingly, when the threshold value or criteria is met, the cluster management framework 101 initiates or generates a request for a corresponding cluster management process (e.g., a rebalancing) that is then processed via the heuristics 301 as described in the process 400 (step 505). For example, a load threshold can be set for the cluster 103 and/or shards within the cluster 103. When the threshold is crossed, rebalancing can be triggered. As such, a database meeting the load threshold can be considered “hot,” for example, being under a heavy load that can be alleviated by the rebalancing. If the threshold criteria are not met, the cluster management framework 101 can record and store the monitoring data as historical data available in, for instance, the persistent layer 303 of the cluster management framework 101 (step 507). The cluster management framework 101 then returns to step 501 to continue monitoring the cluster 103.

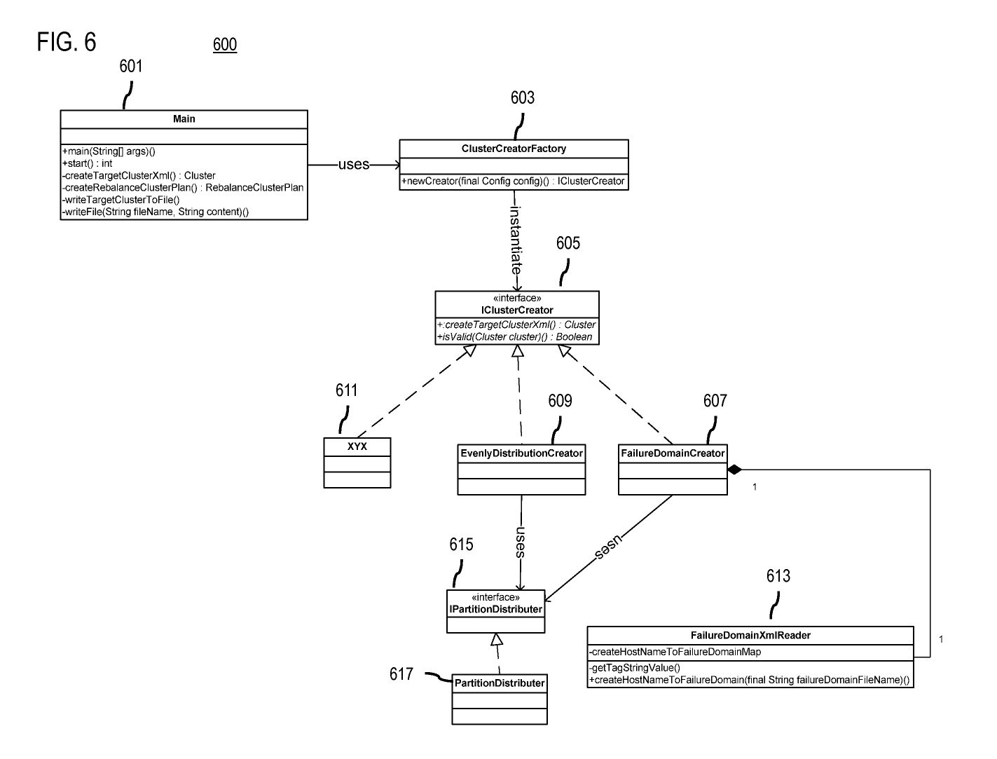

FIG. 6 is a Unified Modeling Language (UML) class diagram of a Java-based cluster management framework, according to various embodiments. In one embodiment, the cluster management framework 101 can be implemented as Java-based program. It is noted that implementation described with respect to FIG. 6 is intended to illustrate one possible embodiment and is not intended to limit a Java-based implementation. In addition, FIG. 6 is a simplification of one example program that is intended to expose the main but not all functionality used by the program. As shown, the UML class diagram 600 provides an extensible design wherein future development of heuristics (e.g., as plug-ins) can be incorporated in the program because of a design that isolates concrete classes and allows changing class-of-family to promote consistency among classes.

More specifically, the diagram 600 depicts a Main class 601 that can initiate one or more cluster management processes (e.g., rebalancing, cluster creation etc.). In one embodiment, the Main class 601 uses a ClusterCreatorFactory class 603 to initiate cluster management processes as previously described. The ClusterCreatorFactory class 603 can then instantiate an instance of the IClusterCreator object 605. In one embodiment, the IClusterCreator object 605 serves as the interface to one or more heuristics. In this example, the heuristics include a FailureDomainCreator class 607, an EvenlyDistributionCreator class 609, and a XYZ class 613.

In one embodiment, the FailureDomainCreator class 607 implements logic for generating a plan to perform a requested cluster management process. As noted above, failure domain is a principle that guides the grouping of nodes or servers 105 under certain circumstances. For example, a failure-domain constitutes a point of failure that can bring down or interrupt the operation of all servers 105 or nodes that are associated to the point of failure. The FailureDomainCreator class 607 assists in determining that servers 105 are distribute across different failure domains. In other words, primary and replica partitions will be spread across different failure domains to ensure that a single failure will not compromise operation of the servers 105 and corresponding primary and replica partitions. In one embodiment, the FailureDomainCreator class 607 interacts with the FailureDomainXmlReader class 613 to read failure domain files that associate the servers 105 of a cluster 103 with one or more failure domains (e.g., via a failure domain identifier). In some embodiments, the failure domain files are specified by the administrator of the cluster 103 or other party with access to the architecture of the cluster 103. In addition or alternatively, the association of the servers 105 with failure domains can be determined based on automated sensors that can report location or other contextual information for classifying the servers 105.

Another example heuristic is the EvenlyDistributionCreator class 609 which provides logic for ensuring that partitions stored in the cluster 105 maintain a balanced geometry. As previously described, the example of FIG. 6 provides for extensibility of heuristics that can be applied. For example, the XYZ class 611 represents a capability to extend program functionality with different heuristic plug-ins that encapsulate a different approach or knowledge to perform a cluster management process (e.g., rebalancing or remapping nodes in the cluster 103). In one embodiment, the heuristic classes 607-611 can then initiate the determined approaches for performing a requested cluster management process via an instance 615 of the PartitionDistributer class 617.

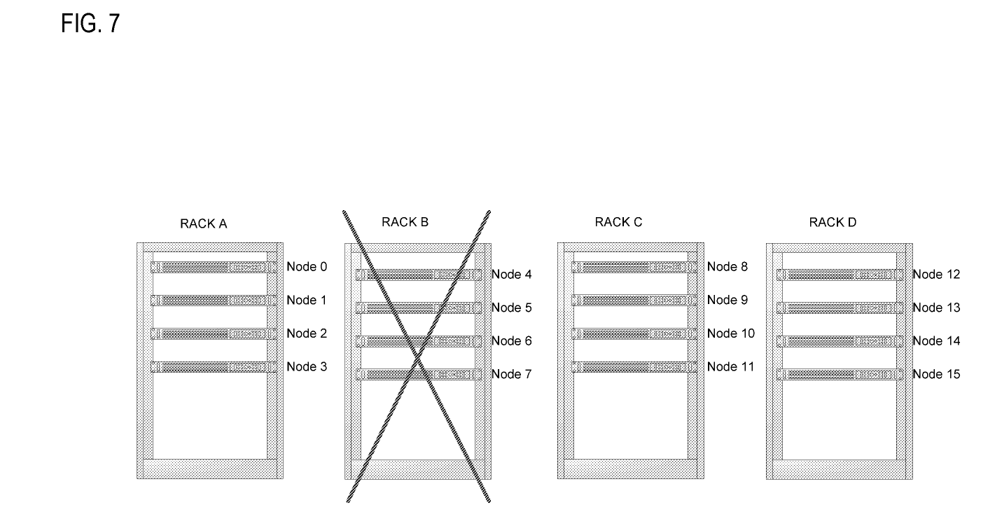

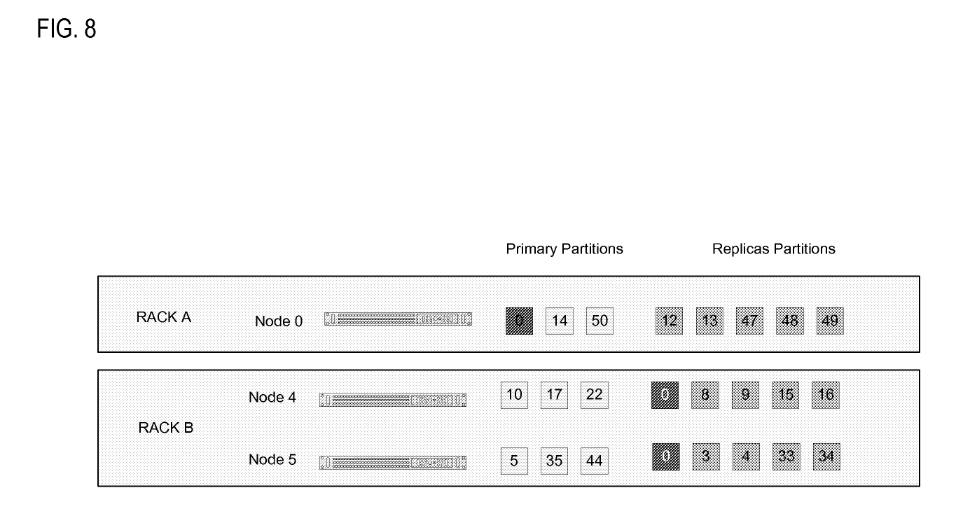

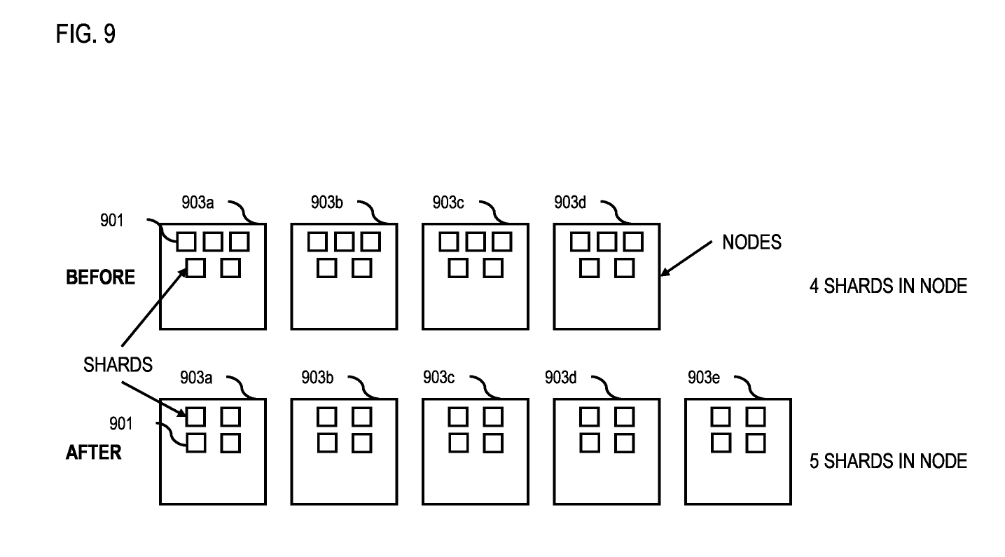

FIGS. 7 and 8 are diagrams of heuristic-based cluster management with respect to a rack-based failure domain, according to various embodiments. The examples of FIGS. 8 and 9 illustrate an example use case where the common failure condition is based on a heuristic 301 that implements “rack-awareness,” wherein each rack of servers 105 represents a single point of failure for all servers 105 connected to it. For example, in an event where a rack is totally disabled, the entire set of servers 105 connected to the failed rack will be affected. Accordingly, a heuristic 301 that is rack-aware will include logic or rules for ensuring that replicate partitions or shards are distribute or balanced in such a way that failure of a rack will not affect all replicas. In other words, a rebalancing plan that is rack-aware should account for not only distribution across different servers 105, but also for the fact that at least one or more replicas have to be distributed across racks with different failure domains.

As shown in FIG. 7, a cluster 103 includes Racks A-D with reach rack associated with four nodes or servers 105. In this example, Rack B suffers a failure event in which the entire rack is down. This failure event brings down Nodes 4-7 which are associated with Rack B. To avoid complete loss of service or data, a rack-aware cluster management framework 101 can apply failure-domain heuristics to ensure that not all replicas of a particular partition or shard are stored only on nodes 4-7. Instead, the cluster management framework 101 can recommend distribution of at least some of the replica partitions to other nodes (e.g., nodes 0-3 or nodes 8-15 located on other racks). In one embodiment, if an administrator attempts to manually move or rebalance a node so that all replicas are located in one rack (e.g., Rack B), the cluster management framework 101 can alert the administrator of the potentially negative consequences of such a move.

For example, the cluster 103 may use a 3/2/2 (Replica=3, Read=2, Write=2) configuration, which means that for each partition there are three copies (e.g., a primary and two replica copies). The quorum requirement for this configuration specifies that, for read and write operations, at least two of the tree copies must be available. Otherwise, the transaction fails. Under this configuration, in order to assure that a replication factor is honored, no identical Rack can have two or more nodes maintaining the same partition P. In other words, if Rack B has two nodes hosting partition P (primary or replica), in case of Rack B failure, these two nodes will also become unavailable, thereby leaving only one node to respond to client requests for keys belonging to partition P. However, because only one node is available, the quorum requirement will be violated and the transaction will fail, thereby compromising system availability.

FIG. 8 depicts application of rack-aware heuristics to a cluster 103 storing both primary and replica partitions. As shown in FIG. 9, Partition 0 is being hosted in three nodes (e.g., Replication=3) across Node 0, Node 4, and Node 5. Node 4 and Node 5 are physically installed in Rack B. If Rack B fails, then Node 4 and Node 5 would become unavailable, leaving only Node 0 handling read/write operations for keys belonging to Partition 0. This results in insufficient node exception which generates a Quorum Exception and leaves the system not available for all keys associated with partition 0. To avoid this Quorum Exception, the failure domain heuristics can include rules that provide for rack awareness so that failure of one rack will not result in loss of a potential quorum for associated partitions.

FIG. 9 is a diagram of a cluster-based rebalancing process, according to various embodiments. The example of FIG. 9 provides an example of applying a heuristic to ensure a balance geometry or even distribution of data within a cluster 103. In this embodiment, shards are utilized as example partitions or portions of databases, however, as noted above, other database structures are considered. Further, shards and/or partitions can be considered databases (e.g., a database that is a subset of a larger database). In this scenario, shards are originally provided utilizing four nodes 903a-903d. Each node 903a-903d, in this example has five shards 901. A rebalancing process is then triggered (e.g., based on the introduction of a new node 903e, based on a trigger in a load capacity of one of the nodes 903, etc.). Rebalancing then occurs to transfer one or more shards 901 to the additional node 903e based, at least in part, on a heuristic to ensure even distribution of the shards.

The processes described herein for providing heuristic-based cluster management may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

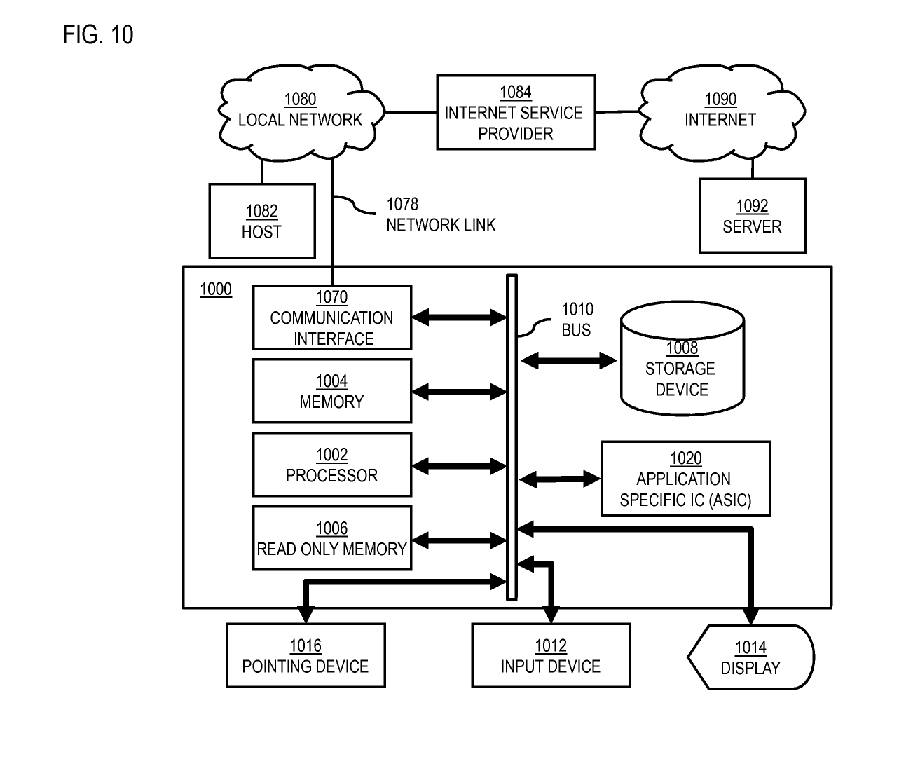

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to provide heuristic-based cluster management as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of providing heuristic-based cluster management.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to providing heuristic-based cluster management. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for providing heuristic-based cluster management. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for providing heuristic-based cluster management, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 111 for providing heuristic-based cluster management.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to provide heuristic-based cluster management as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of providing heuristic-based cluster management.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to provide heuristic-based cluster management. The memory 1105 also stores the data associated with or generated by the execution of the inventive steps.

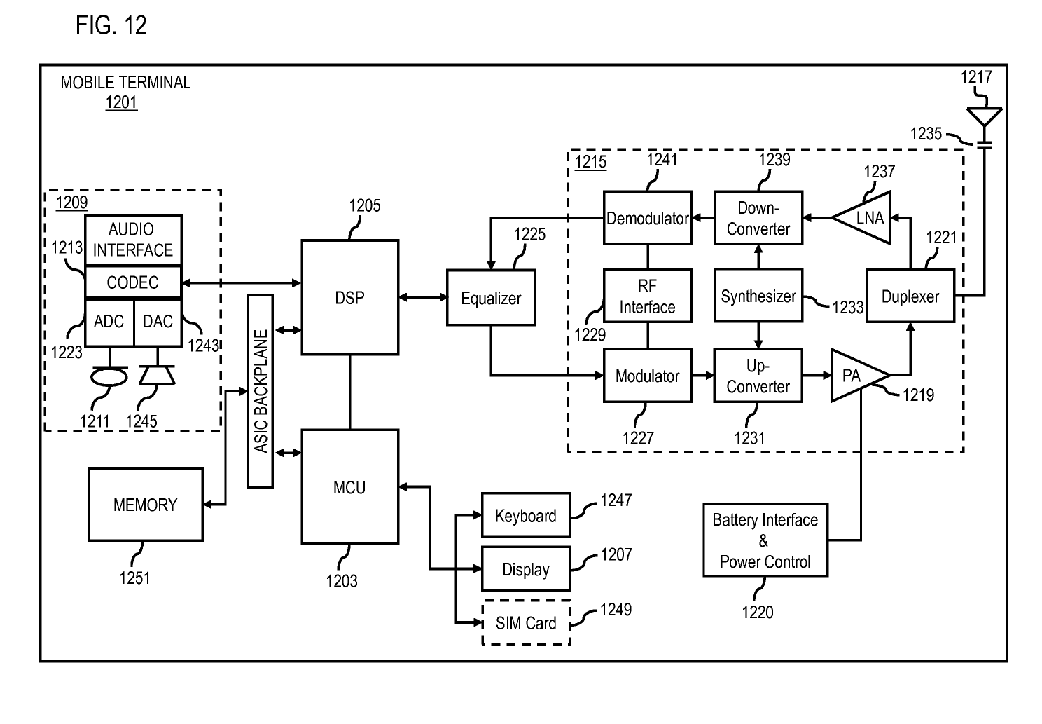

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of providing heuristic-based cluster management. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of providing heuristic-based cluster management. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to provide heuristic-based cluster management. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a request for specifying at least one management process on at least one cluster of one or more servers;
one or more heuristics associated with the at least one management process, the at least one cluster, the one or more servers, or a combination thereof; and
a processing of the one or more heuristics to cause, at least in part, a generation of a plan for implementing the at least one management process.

2. A method of claim 1, wherein the one or more heuristics relate, at least in part, to one or more failure domains, a distribution of data, resource information, or a combination thereof.

3. A method of claim 2, wherein the (1) data and/or (2) information and/or (3) at least one signal are further based, at least in part, on the following:
one or more relationships among the one or more failure domains, the at least one cluster, the one or more servers, or a combination thereof,
wherein the plan is further based, at least in part, on the one or more relationships.

4. A method of claim 3, wherein the (1) data and/or (2) information and/or (3) at least one signal are further based, at least in part, on the following:
a grouping of at least a portion of the one or more servers based, at least in part, on the one or more failure domains,
wherein the one or more relationships are based, at least in part, on the grouping.

5. A method of claim 2, wherein the one or more failure domains are associated, at least in part, with contextual data of the at least one cluster, the one or more servers, or a combination thereof.

6. A method of claim 1, wherein the (1) data and/or (2) information and/or (3) at least one signal are further based, at least in part, on the following:
a monitoring of the at least one cluster, the one or more servers, or a combination thereof; and
determining to generate the request based, at least in part, on the monitoring.

7. A method of claim 1, wherein the (1) data and/or (2) information and/or (3) at least one signal are further based, at least in part, on the following:
a processing of the monitoring to determine use information of the at least one cluster, the one or more servers, or a combination thereof,
wherein the plan is further based, at least in part, on the use information.

8. A method of claim 1, wherein the (1) data and/or (2) information and/or (3) at least one signal are further based, at least in part, on the following:
an initiation of the at least one management process based, at least in part, on the generation of the plan.

9. A method of claim 1, wherein the (1) data and/or (2) information and/or (3) at least one signal associated with the processing of the one or more heuristics are further based, at least in part, on the following:
at least one schedule, at least one means, or a combination thereof for the at least one management process.

10. A method of claim 1, wherein the at least one management process includes, at least in part, (a) a rebalancing of the cluster in response to an addition of at least one other server, a decommissioning of at least one of the one or more servers, or a combination thereof, (b) a predictive analysis of the at least one cluster, (c) a capacity analysis of the at least one cluster, or (d) a combination thereof.

11. An apparatus comprising:
at least one processor; and
at least one memory including computer program code for one or more programs,
the at least one memory and the computer program code configured to, with the at least one processor, cause the apparatus to perform at least the following,
receive a request for specifying at least one management process on at least one cluster of one or more servers;
determine one or more heuristics associated with the at least one management process, the at least one cluster, the one or more servers, or a combination thereof and
process and/or facilitate a processing of the one or more heuristics to cause, at least in part, a generation of a plan for implementing the at least one management process.

12. An apparatus of claim 11, wherein the one or more heuristics relate, at least in part, to one or more failure domains, a distribution of data, resource information, or a combination thereof.

13. An apparatus of claim 12, further comprising:
determining one or more relationships among the one or more failure domains, the at least one cluster, the one or more servers, or a combination thereof,
wherein the plan is further based, at least in part, on the one or more relationships.

14. An apparatus of claim 13, further comprising:
causing, at least in part, a grouping of at least a portion of the one or more servers based, at least in part, on the one or more failure domains,
wherein the one or more relationships are based, at least in part, on the grouping.

15. An apparatus of claim 12, wherein the one or more failure domains are associated, at least in part, with contextual data of the at least one cluster, the one or more servers, or a combination thereof.

16. An apparatus of claim 11, further comprising:
causing, at least in part, a monitoring of the at least one cluster, the one or more servers, or a combination thereof; and
determining to generate the request based, at least in part, on the monitoring.

17. An apparatus of claim 11, further comprising:
processing and/or facilitating a processing of the monitoring to determine use information of the at least one cluster, the one or more servers, or a combination thereof,
wherein the plan is further based, at least in part, on the use information.

18. An apparatus of claim 11, further comprising:
causing, at least in part, an initiation of the at least one management process based, at least in part, on the generation of the plan.

19. An apparatus of claim 11, wherein the processing comprises, at least in part:
determining at least one schedule, at least one means, or a combination thereof for the at least one management process.

20. An apparatus of claim 11, wherein the at least one management process includes, at least in part, (a) a rebalancing of the cluster in response to an addition of at least one other server, a decommissioning of at least one of the one or more servers, or a combination thereof, (b) a predictive analysis of the at least one cluster, (c) a capacity analysis of the at least one cluster, or (d) a combination thereof.

21-48. (canceled)
